(19) United States
(12) Patent Application Publication
(10) Pub. No.: US 2017/0216005 A1
(43) Pub. Date: Aug. 3, 2017

(54) METHOD FOR SPREADING BOLUS PARTICLES, DEVICE FOR OBSERVING BOLUS PARTICLES, METHOD FOR CREATING LIQUID MIXTURE, AND WASHER

(71) Applicant: NATIONAL UNIVERSITY CORPORATION OKAYAMA UNIVERSITY, Okayama-shi, Okayama (JP)

(72) Inventors: Shogo MINAGI, Okayama-shi, Okayama (JP); Kyoko SUGIMOTO, Akaiwa-Shi, Okayama (JP)

(73) Assignee: NATIONAL UNIVERSITY CORPORATION OKAYAMA UNIVERSITY, Okayama-shi, Okayama (JP)

(21) Appl. No.: 15/515,217

(22) PCT Filed: Mar. 30, 2016
(86) PCT No.: PCT/JP2016/060567

§ 371 Date: Mar. 29, 2017

(30) Foreign Application Priority Data
Jun. 1, 2015 (JP) 2015-111746

(51) Int. Cl. A61C 19/04

(52) U.S. Cl. CPC A61C 19/04

(57) ABSTRACT

A liquid mixture obtained by mixing a bolus and an adjusting agent is poured into a tray-shaped container, and during spreading of bolus particles constituting the bolus along the bottom surface, the tray-shaped container is placed in a first inclined state in which the bottom surface is inclined by increasing the height of one edge side in the left-right direction of the tray-shaped container relative to the other edge side thereof, and the liquid mixture in the tray-shaped container is moved toward the other edge side, after which the tray-shaped container is placed in a second inclined state in which the bottom surface is inclined in the reverse direction by reducing the height of one edge side of the tray-shaped container relative to the other edge side thereof, after which the bottom surface is placed in a horizontal state, and the bolus particles are thereby spread.

### TECHNICAL FIELD

In order to create a bolus by causing food to be chewed by a subject and evaluate masticatory ability by measuring size distribution of bolus particles constituting the bolus, the present invention relates to a method for spreading the bolus particles as uniformly as possible, an observation device for observing the spread bolus particles, a method for preparing a liquid mixture including the bolus particles, and a washer for preparing the liquid mixture.

### BACKGROUND ART

It is very important for a human to chew food well, and it is pointed out that imperfect chewing may ruin health. Especially, when a tooth is worsened and capped or equipped with a false tooth, masticatory ability is changed corresponding to a state of the tooth.

Conventionally, concerning a method for evaluating ability of chewing food of a person, there is no unific method, and various methods are proposed.

For example, a method is proposed that an object chews chewing gum whose color is changed by being chewed for predetermined number, and masticatory ability is evaluated from difference between the predetermined number and a number presumed from color difference between the chewing gum before chewed and that after chewed (for example, see the Patent Literature 1).

Otherwise, it is proposed that a gummi candy for evaluation crunched by being chewed is used so as to evaluate the masticatory ability (for example, see the Patent Literature 2).

Furthermore, it is proposed that gummi jelly which is crunched by being chewed and exudes a coloring matter is used and density of the exuded coloring matter is measured so as to presume surface area of the gummi jelly increased by being chewed, whereby the masticatory ability is evaluated from change amount of the surface area (for example, see the Patent Literature 3).

Concerning the evaluation using soft food such as the chewing gum or the jelly, partial evaluation of the masticatory ability can be performed. However, for example, concerning meal for elderly people, what mode among mixer food, minced food, bite-sized food, normal food and the like is suitable cannot be judged correctly.

As a result of various research and evaluations, the inventors result in the conclusion that the evaluation of the masticatory ability for the purpose of provision of food suitable for the masticatory ability is preferably performed by chewing normal food instead of the above soft food. Especially, a bolus is prepared by making an object chew normal food and size distribution of bolus particles constituting the bolus so as to evaluate the masticatory ability.

Concretely, the bolus is prepared by making the object chew the normal food and the bolus is spread in liquid such as water so as to make the bolus particles discriminable respectively, and dispersion liquid of the bolus particles is phoned with a digital still camera or the like so as to generate image data. Then, the image data is analyzed so as to specify and total sizes of the bolus panicles.

Especially, in the case of acquiring image of the dispersion liquid of the bolus particles so as to generate the image data, for preventing indistinctness of a focus causing incorrect recognition of shape of the bolus particles, the dispersion liquid of the bolus particles is spread thinly in a flat tray such as a schale so as to make focusing to the bolus particles easy.

### PRIOR ART REFERENCE

### Patent Literature

Patent Literature 1: the Japanese Patent Laid Open Gazette 2013-90830

Patent Literature 2: the Japanese Patent Laid Open Gazette 2012-170424

Patent Literature 3: the Japanese Patent Laid Open Gazette 2012-45196

### DISCLOSURE OF INVENTION

### Problems to be Solved by the Invention

For recognizing correctly the bolus particles respectively, preferably, the adjacent bolus particles have a suitable interval, and the bolus particles must be photted after adjusting positions of the bolus particles by hand. Accordingly, generation of the image data requires much time and there is a problem that inspection efficiency is very low In consideration of the present condition, the inventors have performed research and development so that the image data is generated skillfully by spreading and arranging the bolus particles more easily so as to evaluate the masticatory ability easily, whereby the present invention is provided.

### Means for Solving the Problems

In a method for spreading bolus particles that a liquid mixture of a bolus and adjusting agent is poured into a tray-shaped container and the bolus particles constituting the bolus are spread along a bottom surface of the tray-shaped container according to the present invention, the tray-shaped container has the rectangular bottom surface and a direction along a side edge of the rectangular bottom surface is regarded as a lateral direction, the liquid mixture is poured into the tray-shaped container, a first inclined state in which the bottom surface is inclined is realized by making one of lateral ends higher than the other end and the liquid mixture in the tray-shaped container is moved toward the other end, subsequently, a second inclined state in which the bottom surface is inclined oppositely is realized by making the one lateral end lower than the other end, and subsequently, the bottom surface is changed to a horizontal state so as to spread the bolus particles.

Furthermore, the method for spreading bolus panicles according to the present invention is characterized in below points.

(1) A timing of changing the bottom surface from the first inclined state to the second inclined state is a timing at which a reverse flow occurs in the liquid mixture moving to the other end by changing the bottom surface to the first inclined state.

(2) A timing of changing the bottom surface from the second inclined state to the horizontal state is a timing at which a reverse flow occurs in the liquid mixture moving to the one end by changing the bottom surface to the second inclined state.

(3) The operation changing the bottom surface to the first inclined state and the operation changing the bottom surface to the second inclined state are repeated by turns several times.

An observation device for bolus particles according to the present invention has a tray-shaped container to which a liquid mixture of a bolus and adjusting agent is poured, a housing having a mounting stand on which the tray-shaped container is mounted, and a camera provided in an inside of the housing and acquiring image of the tray-shaped container so as to generate image data of bolus particles spread in the tray-shaped container, and characterized in below points. The mounting stand can be changed to a horizontal posture in which a bottom surface of the tray-shaped container is in a horizontal state, a first inclined posture realizing a first inclined state in which the bottom surface of the tray-shaped container is inclined for a predetermined angle, and a second inclined posture realizing a second inclined state in which the bottom surface of the tray-shaped container is inclined oppositely to the first inclined posture. The bottom surface is changed from the horizontal state to the first inclined state, and a timing of changing the bottom surface from the first inclined state to the second inclined state is a timing at which a reverse flow occurs in the liquid mixture moving by changing the bottom surface to the first inclined state, and a timing of changing the bottom surface from the second inclined state to the horizontal state is a timing at which a reverse flow occurs in the liquid mixture moving by changing the bottom surface to the second. inclined state.

A method for preparing the liquid mixture of the bolus and the adjusting agent according to the present invention has a step washing the bolus with a first surfactant, and a step washing the bolus with a second surfactant having polarity different from the first surfactant. Furthermore, the first surfactant is liquid whose main component is Yashinomi detergent and the second surfactant is liquid whose main component is Osvan liquid. Moreover, the adjusting agent is the second surfactant.

A washer used for preparing the liquid mixture according to the present invention has a container which is a cylinder with a bottom and houses the bolus, and a cap body which can be attached detachably to an opening of the container. In the cap body, a mesh surface having many fine holes through which washing liquid washing the bolus can flow is provided. Especially, the container is configured by a cylindrical syringe and a plunger slidably inserted into one of ends of the syringe, and the plunger is reciprocated concerning the syringe so as to make the washing liquid flow via the mesh surface into a body of the washer and flow out from the body of the washer.

### Effect of the Invention

According to the present invention, the bolus particles constituting the bolus can be spread certainly and very easily so as to evaluate the masticatory ability quickly.

### BRIEF DESCRIPTION OF DRAWINGS

FIG. 1 is an explanation drawing of a washer for a bolus.

FIG. 2 is an explanation drawing of a method for washing the bolus with the washer.

FIG. 3 is an explanation drawing of a method for washing the bolus with the washer.

FIG. 4 is an explanation drawing of a washer for the bolus.

FIG. 5 is an explanation drawing of a method for using the washer of the bolus.

FIG. 6 is an explanation drawing of a method for washing the bolus with the washer.

FIG. 7 is a sectional schematic view of an observation device for bolus particles.

FIG. 8 is a sectional schematic view of an observation device for the bolus particles.

FIG. 9 is a picture of the state in which liquid mixture washed and adjusted its amount is poured into a tray-shaped container.

FIG. 10 is a picture of the state in which a bottom surface of the tray-shaped container is turned into a horizontal state, a first inclined state and the horizontal state so as to spread the bolus particles.

FIG. 11 is a picture of the state in which the bottom surface of the tray-shaped container is turned into the horizontal state, the first inclined state, a second inclined state and the horizontal state so as to spread the bolus particles.

### DETAILED DESCRIPTION OF THE INVENTION

According to the present invention, bolus particles constituting a bolus by causing food to be chewed by a subject can be spread certainly and very easily, and size distribution of the spread bolus particles is measured so as to evaluate masticatory ability quickly.

A detailed explanation is given below along actual operation steps. The food to be chewed by the subject is preferably food that shape of pieces can be identified easily when the food is crunched comparatively small. However, the food may be a fresh vegetable such as a cabbage or a carrot, or comparative soft food such as boiled rice when number of chewing times is small. Otherwise, the food may be compound food in which hard food and soft food are mixed, such as takikomi rice or stir-fried vegetables.

### <Preparation of Bolus>

Firstly, food is chewed by a subject, and after predetermined number of chewing, food is discharged as a bolus to a schale or the like.

### <Washing of Bolus>

The bolus is mixed with saliva, and the saliva is removed by washing the bolus. Since bolus particles which become fine by enough chewing are not necessary to be counted at the time of counting the bolus particles, the fine particles which are not necessary to be counted are also removed.

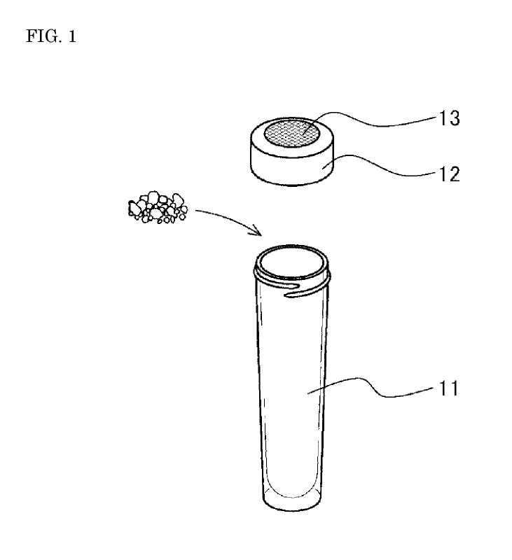

A washer is used for washing the bolus. As shown in FIG. 1, the washer includes a container 11 which is a cylinder with a bottom and houses the bolus and a cap body 12 which can be attached detachably to an opening of the container 11. Especially, in the cap body 12, a mesh surface 13 having many fine holes through which washing liquid washing the bolus can flow is provided. A diameter of each of the fine holes of the mesh surface 13, that is, mesh size should be enough for suppressing passage of the bolus particles with the size to be counted as the bolus particles, and the diameter of the hole is 0.2 mm in this embodiment.

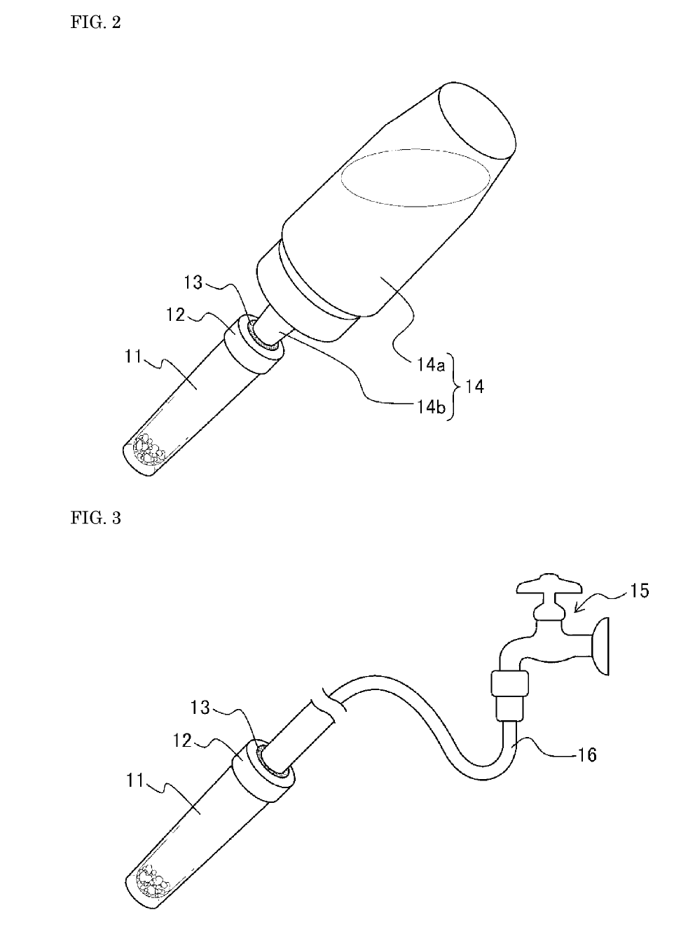

At the time of washing the bolus, the bolus of predetermined amount is put into the blank container 11 with a medicine spoon or the like, the cap body 12 is attached to the container 11, and as shown in FIG. 2, the washing liquid is poured into the container 11 via the mesh surface 13 so as to wash the bolus in the container 11.

In FIG. 2, a numeral 14 shows a washing liquid container in which the washing liquid is stored. A body part 14a of the washing liquid container 14 is flexible, and by grasping strongly the body part 14a by hand, the washing liquid in the washing liquid container 14 can be pushed out. In the washing liquid container 14, a tapered nozzle 14b is provided so as to make the washing liquid easy to be poured via the mesh surface 13 into the container 11.

The washing liquid poured into the container 11 may be water in addition to a surfactant such as Yashinomi detergent or Osvan liquid discussed later. Especially, when the bolus is washed by the water, as shown in FIG. 3, the water may be poured directly from a faucet 15 of water service via proper hose 16. Especially, by making the water overflow from the container 11 while pouring the water into the container 11, washing with short time is enabled.

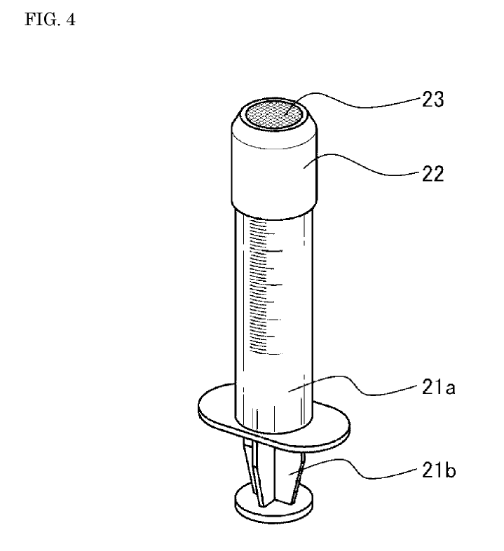

As another mode of the washer, as shown in FIG. 4, the container in which the bolus is stored may be configured by a cylindrical syringe 21a and a plunger 21b slidably inserted into one of ends of the syringe 21a. Especially, in this embodiment, in the other end of the syringe 21a to which the plunger 21b is not inserted, a cone part for attaching a needle in a normal syringe is cut off so as to form an opening, and a cap body 22 can be engaged detachably with the opening. The cap body 22 is a cylinder with a bottom, and in the bottom, a mesh surface 23 having many fine holes through which washing liquid washing the bolus can flow is provided. A diameter of each of the fine holes of the mesh surface 23 is also 0.2 mm. For convenience of an explanation, the washer configured by the syringe 21a, the plunger 21b and the cap body 22 is referred to as a syringe type washer.

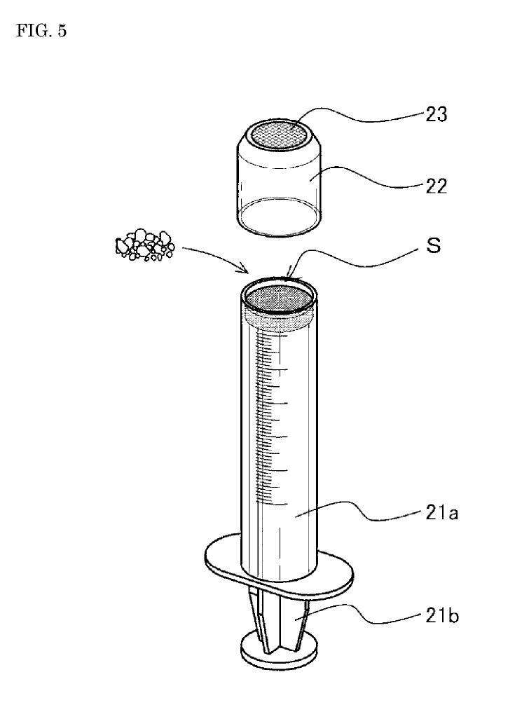

In the case of washing the bolus with the syringe type washer, firstly, as shown in FIG. 5, the cap body 22 is detached from the syringe 21a and the plunger 21b is inserted deeply into the syringe 21a so as to form a storage space S whose bottom surface is a tip surface of the plunger 21b. Subsequently, the bolus of the predetermined amount is put into the storage space S with the medicine spoon or the like, and the cap body 22 is attached to a tip of the syringe 21a as shown in FIG. 4.

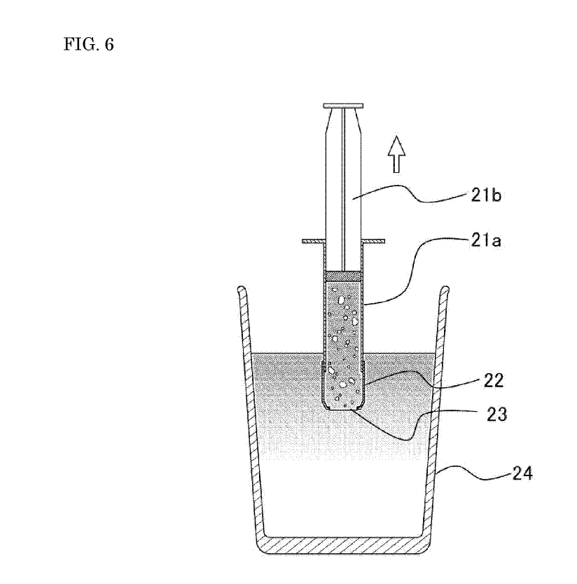

Subsequently, as shown in FIG. 6, the cap body 22 of the syringe type washer is immersed in a washing bath 24 in which the washing liquid is pooled, and the plunger 21b is pulled back so as to make the washing liquid flow into the syringe type washer, thereby washing the bolus.

Especially, the plunger 21b is reciprocated concerning the syringe 21a while the cap body 22 of the syringe type washer is immersed in the washing bath 24 so as to make the washing liquid flow via the mesh surface 23 into the syringe 21a which is a body of the washer and flow out from the syringe 21a repeatedly, whereby the washing is performed more certainly.

The washing with the water may alternatively be performed so that the cap body 22 is directed upward and the plunger 21b is pulled back, and as shown in FIG. 3, the water is poured from the faucet 15 of the water service via the proper hose 16 through the mesh surface 23 of the cap body 22 so as to perform the washing.

Herein, in the syringe 21a, preferably, a volume scale which is provided in a general syringe is displayed. By using the volume scale, in the case of preparing a liquid mixture by mixing the bolus and adjusting agent as discussed later, an amount of the liquid mixture can be adjusted easily to a predetermined amount so as to spread the bolus particles stably.

In the washing of the bolus with the washer mentioned above, by using at least two kinds of surfactants, the saliva in the bolus can be removed certainly. Namely, preferably, the washing of the bolus with the washer includes two or more steps including a step of the washing with a first surfactant and a step of the washing with a second surfactant having polarity different from the first surfactant.

Especially, preferably, the first surfactant is an anionic surfactant, and the Yashinomi detergent which is used generally as a household detergent is used in this embodiment. Namely, the first surfactant is liquid whose main component is the Yashinomi detergent prepared by diluting the Yashinomi detergent with water.

Preferably, the second surfactant is a cationic surfactant, and the Osvan liquid also known as a germicidal disinfectant is used in this embodiment. Namely, the second surfactant is liquid whose main component is the Osvan liquid prepared by diluting the Osvan liquid with water.

The bolus may be washed with the water roughly previously before washing the bolus with the first surfactant so as to improved washing effect of the first surfactant. The washing with the water may be performed between the washing with the first surfactant and the washing with the second surfactant so as to prevent the first surfactant from being mixed with the second surfactant.

### <Preparation of Mixture Liquid>

The washed bolus is mixed with the adjusting agent so as to prepare the liquid mixture. In this embodiment, the second surfactant is used as the adjusting agent. Namely, by preparing the liquid mixture with the adjusting agent including the surfactant, the state that the bolus particles are spread in the liquid mixture can be maintained easily.

Concretely, after washing the bolus with the second surfactant, the second surfactant in the washer is discharged as much as possible, and subsequently, about 10 ml of the second. surfactant is injected as the adjusting agent into the washer so as to prepare the liquid mixture. Especially, in the syringe type washer, the amount of the liquid can be adjusted by using the volume scale provided in the syringe 21a.

The liquid mixture in the washer is dispersion liquid of the bolus particles. The liquid mixture is poured into a tray-shaped container, the tray-shaped container is mounted on a predetermined. position of an observation device for the bolus particles, and size distribution of the bolus panicles is measured.

### <Configuration of Observation Device for Bolus Particles>

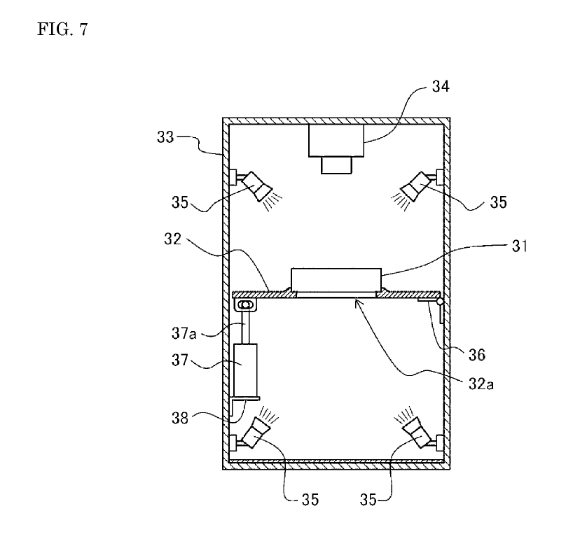

As shown by a sectional schematic view of FIG. 7, the observation device for the bolus particles is configured by the tray-shaped container 31 to which the liquid mixture is poured, a housing 33 having a mounting stand 32 on which the tray-shaped container 31 is mounted, and a camera 34 provided in an inside of the housing 33 and acquiring image of the tray-shaped container 31 so as to generate image data of the bolus particles spread in the tray-shaped container 31.

The camera 34 is a digital camera and connected to an analysis device (not shown) such as a personal computer provided outside the housing 33 and output the image data to the analysis device. In the analysis device, the bolus particles are specified in the inputted image data, and sizes of the bolus particles are specified and totaled so as to generate size distribution data of the bolus particles. Especially, since evaluation of masticatory ability is performed by using the size distribution data of the bolus particles, an amount of the bolus particles included in the liquid mixture is supposed to be unrelated.

The tray-shaped container 31 to which the liquid mixture of the bolus and the adjusting agent is poured has a rectangular bottom surface, and is a rectangle whose inner dimensions are 78 mm×173 mm. In this embodiment. For rocking the tray-shaped container 31 as discussed later, preferably, the tray-shaped container 31 is rectangular when viewed in plan. However, by adjusting rocking conditions, a tray-shaped container which is not rectangular when viewed in plan may be used. On the relation of lighting which illuminates the bolus particles, preferably, the tray-shaped container 31 is transparent, and is made by transparent glass in this embodiment.

The housing 33 is rectangular and an inner side thereof is black so as to prevent dispersion of light.

The mounting stand 32 on which the tray-shaped container 31 is mounted is provided horizontally at a substantially vertical center of the rectangular housing 33. Especially, the mounting stand 32 has an opening 32a at a mounting position of the tray-shaped container 31 and supports an outer peripheral edge of the tray-shaped container 31. Through the opening 32a provided in the mounting stand 32, lighting implements 35 provided below the mounting stand 32 emit light to the bolus particles in the tray-shaped container 31, and emits light together with the lighting implements 35 provided above the mounting stand 32 so as not to generate any shadow of the bolus particles so as to prevent error judgement of the size of the bolus particles.

Furthermore, one of ends of the mounting stand 32 is attached via a hinge 36 to the housing 33 and the other end thereof is attached to a tip of an actuator 37 having a rod 37a and drives the rod 37a reciprocally so that the mounting stand 32 can be rotated centering on an axis of the hinge 36.

Herein, the tray-shaped container 31 mounted on the mounting stand 32 has the rectangular bottom surface having longer sides and shorter sides, and preferably mounted on the mounting stand 32 while the shorter sides are in parallel to the axis of the hinge 36 and the longer sides are perpendicular to the axis of the hinge 36. A direction of the longer sides in this case, that is, a direction along a side edge of the rectangular bottom surface of the tray-shaped container 31 is regarded as a lateral direction.

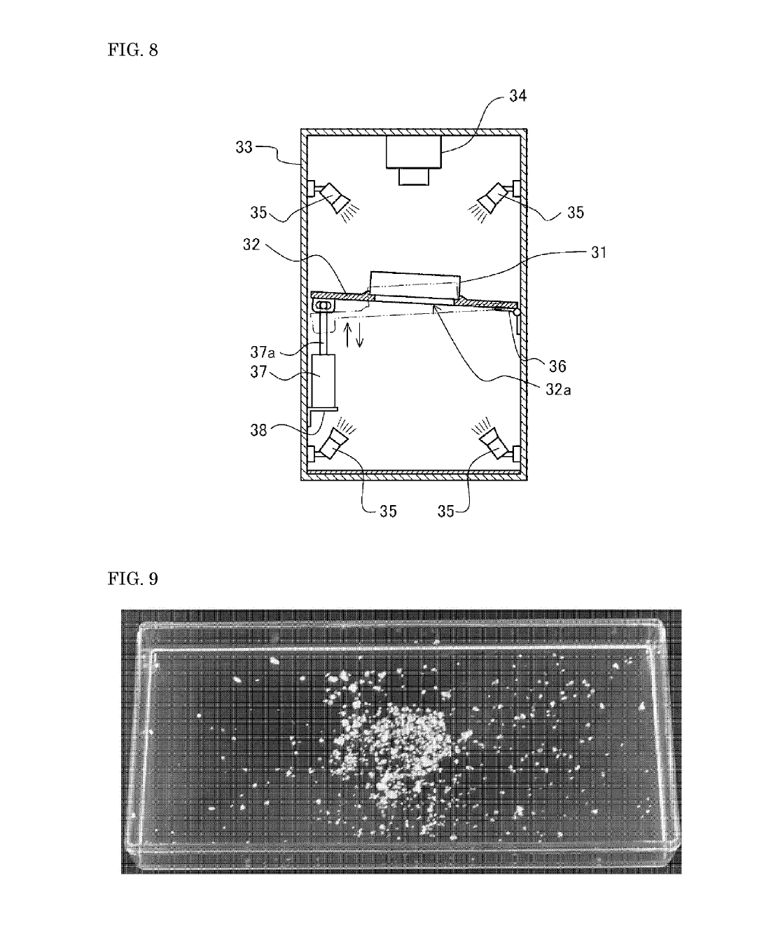

By rotating the mounting stand 32 suitably, the tray-shaped container 31 mounted on the mounting stand 32 can be changed to a horizontal posture in which the bottom surface of the tray-shaped container 31 is horizontal, a first inclined posture in which the bottom surface of the tray-shaped container 31 is inclined for a predetermined angle, and a second inclined posture in which the bottom surface of the tray-shaped container 31 is inclined oppositely to the first inclined posture as shown in FIG. 8. In this embodiment, a support stand 38 equipped with the actuator 37 is provided below the mounting stand 32, and the actuator 37 is attached on the support stand 38. However, any mechanism which can make the tray-shaped container 31 into the predetermined postures as mentioned above can be used.

Especially, in the observation device for the bolus particles, a switch (not shown) driving the actuator 37 is provided, and the actuator 37 is driven as discussed below by operating the switch so as to spread the bolus particles in the liquid mixture poured to the tray-shaped container.

At the beginning, the mounting stand 32 is horizontal. Firstly, the actuator 37 extends the rod 37a so as to make the mounting stand 32 into the first inclined posture sinking to the right shown in FIG. 8 by solid lines so that one of lateral ends (left end in FIG. 8) of the tray-shaped container 31 is raised rather than the other end (right end in FIG. 8), whereby the liquid mixture in the tray-shaped container 31 is moved toward the other end. The inclination state of the bottom surface inclined by raising the one of the lateral ends of the tray-shaped container 31 rather than the other end as the above is referred to as a first inclination state.

Subsequently, the actuator 37 contracts the rod 37a so as to make the mounting stand 32 into the second inclined posture rising to the right shown in FIG. 8 by two-dot chain lines so that the one of the lateral ends (left end in FIG. 8) of the tray-shaped container 31 is pulled down rather than the other end (right end in FIG. 8), whereby the liquid mixture in the tray-shaped container 31 is moved toward the one end. The inclination state of the bottom surface inclined by lowering the one of the lateral ends of the tray-shaped container 31 rather than the other end as the above is referred to as a second inclination state.

Subsequently, the actuator 37 extends the rod 37a so as to return the mounting stand 32 to the horizontal state.

An inclination angle of the first inclined state and the second inclined state should be enough to cause movement of the liquid mixture in the tray-shaped container 31 and may be about 10° at largest, and is about 3° in this embodiment.

Accordingly, by changing the bottom surface of the tray-shaped container 31 to which the liquid mixture is poured to the horizontal state, the first inclined state, the second inclined state and the horizontal state in this order, the bolus particles in the tray-shaped container 31 can be spread relatively uniformly. The first inclined state and the second inclined state may be repeated by turns several times, and in this case, the state may be returned from the first inclined state to the horizontal state. Otherwise, after changing the bottom surface of the tray-shaped container 31 to which the liquid mixture is poured to the horizontal state, the first inclined state, the second inclined state and the horizontal state in this order by operating the switch, when the bolus particles in the tray-shaped container 31 is not spread enough, the switch may be operated again.

Especially, in the case in which the bottom surface of the tray-shaped container 31 is changed from the horizontal state to the first inclined state and then changed to the second inclined state, the state may be changed directly from the first inclined state to the second inclined state, or may alternatively be stopped briefly at a state between the first inclined state and the second inclined state, such as the horizontal state, and then changed to the second inclined state. When the inclination angles of the first inclined state and the second inclined state are relatively large, by taking a brief recess at the time of changing from the first inclined state to the second inclined state, excessive increase of movement speed of the liquid mixture in the tray-shaped container 31 caused by the inclination can be suppressed, thereby preventing leakage of the liquid mixture from the tray-shaped container 31. In the case of providing the brief recess, though the movement speed of the liquid mixture in the tray-shaped container 31 is changed, a movement direction of the liquid mixture in the tray-shaped container 31 is not changed, and the operation changing the bottom surface of the tray-shaped container 31 from the first inclined state to the second inclined state includes the brief recess.

Herein, a timing of changing the bottom surface of the tray-shaped container 31 from the first inclined state to the second inclined state is a timing at which a reverse flow occurs in the liquid mixture moving to the other end (right end in FIG. 8) of the tray-shaped container 31 by changing the bottom surface to the first inclined state.

The liquid mixture flows to the end of the tray-shaped container 31 which becomes a downstream. side by changing the bottom surface of the tray-shaped container 31 to the first inclined state. When an amount of the entering mixture liquid is large, a flow of the entering direction is superior and a reverse flow does not exist. However, at a middle, the amount of the entering mixture liquid is reduced so that the flow of the entering direction becomes weaker, whereby the reverse flow is generated. Preferably, at the timing of generation of the reverse flow, the bottom surface of the tray-shaped container 31 is changed from the first inclined state to the second inclined state.

Especially, when the entering of the liquid mixture to the end of the tray-shaped container 31 which becomes the downstream side occurs, in the liquid mixture pooled at the end, a rotation flow is generated from the end to the bottom surface of the tray-shaped. container 31. The inventors refer the rotation flow as a bottom surface flow. By the bottom surface flow; relatively small particles of the bolus particles are considered to be made flow violently so as to cause churning effect.

Similarly, a timing of changing the bottom surface of the tray-shaped container 31 from the second inclined state to the horizontal state is a timing at which a reverse flow occurs in the liquid mixture moving to the one end (left end in FIG. 8) of the tray-shaped container 31 by changing the bottom surface to the second inclined state.

Similarly to the timing of changing the bottom surface of the tray-shaped container 31 from the first inclined state to the second inclined state, preferably, the bottom surface of the tray-shaped container 31 is changed from the second inclined state to the horizontal state in the state in which the bottom surface flow is generated.

In this embodiment, the bottom surface of the tray-shaped container 31 is rectangular and the direction along the side edge of the rectangular bottom surface of the tray-shaped container 31 is regarded as the lateral direction, and the bottom surface of the tray-shaped container 31 is inclined sinking to the right or rising to the right in the lateral direction so as to generate the bottom surface flow. For example, concerning a container which is circular when viewed in plan such as a schale, when a bottom surface is inclined similarly, a flow other than the bottom surface flow is generated h a side wall curved circularly. Accordingly, the bolus particles cannot be spread uniformly in the schale.

Conditions generating the bottom surface flow receive influence in size and shape of the bottom surface of the tray-shaped container 31 and an amount of the mixed liquid poured into the tray-shaped container 31. Accordingly, preferably, an optimum driving condition of the actuator 37 is found corresponding to the tray-shaped container 31 and the amount of the mixed liquid,

After changing the bottom surface of the tray-shaped container 31 from the second inclined state to the horizontal state, an attenuating wave is generated in the mixed liquid in the tray-shaped container 31, and when the attenuating wave disappears and positional movement of the bolus particles is not found, the image data is generated.

Below, the state in which the bolus particles are spread actually is shown. FIG. 9 is a photo of the state in which the bolus is washed with the syringe type washer and the liquid mixture adjusted its amount is poured into the tray-shaped container 31. In this case, the bolus is made by a peanut.

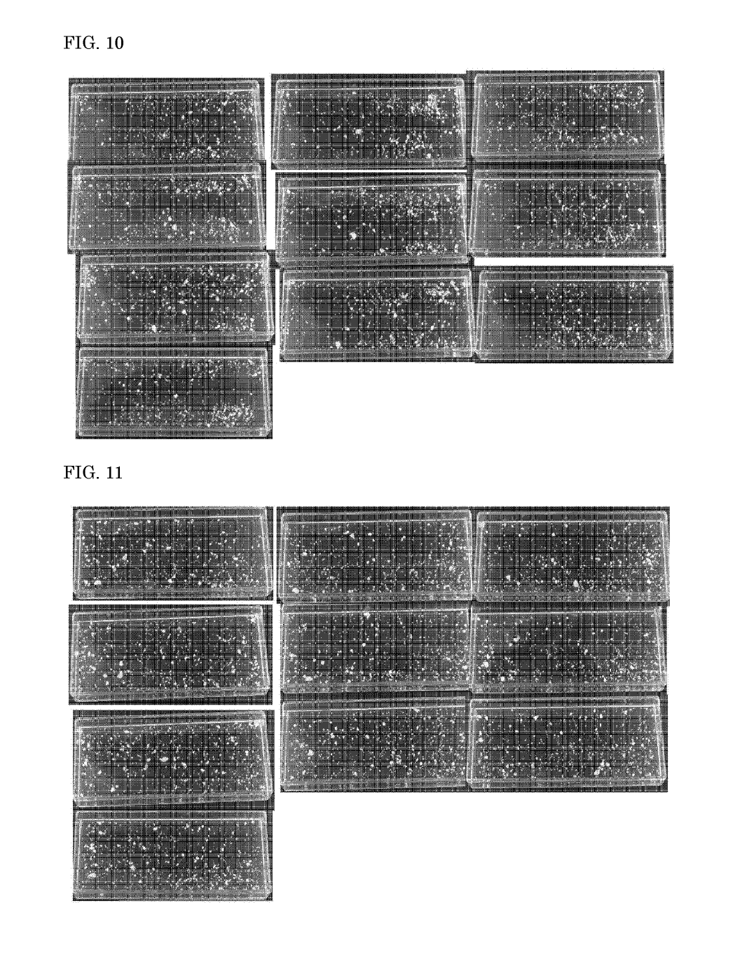

FIG. 10 shows the spreading state of the bolus particles in the case in which the bottom surface of the tray-shaped container 31 in the state of FIG. 9 is changed from the horizontal state to the first inclined state so as to generate the bottom surface flow and subsequently the bottom surface of the tray-shaped container 31 is changed to the horizontal state except for the second inclined state. FIG. 10 shows collectively results of trials of 10 times. In some cases, the bolus particles are spread relatively uniformly. However, roughness and fineness of the especially fine bolus particles is generated and it is not suitable to generate the image data. with the observation device for the bolus particles. Normally, in this state, the bolus particles are spread manually and the image data is generated with an observation device for the bolus particles which does not have the rocking mechanism.

On the other hand, FIG. 11 shows the spreading state of the bolus particles in the case in which the bottom surface of the tray-shaped container 31 in the state of FIG. 9 is changed from the horizontal state to the first inclined state so as to generate the bottom surface flow, and subsequently the bottom surface of the tray-shaped container 31 is changed to the second inclined state so as to generate the bottom surface flow, and subsequently the bottom surface of the tray-shaped container 31 is changed to the horizontal state. FIG. 11 shows results of trials of 10 times. In each of the cases, the bolus particles are spread uniformly, and it is confirmed that the spreading method according to the present invention is effective.

### DESCRIPTION OF NOTATIONS

11 container
12 cap body
13 mesh surface
21a syringe
21b plunger
22 cap body
23 mesh surface
31 tray-shaped container
32 mounting stand
32a opening
33 housing
34 camera
35 lighting implement
36 hinge
37a rod
37 actuator
38 support stand

What is claimed is:

1. A method for spreading bolus particles in which a liquid mixture of a bolus and adjusting agent is poured into a tray-shaped container and the bolus particles constituting the bolus are spread along a bottom surface of the tray-shaped container,
characterized in that
the tray-shaped container has the rectangular bottom surface and a direction along a side edge of the rectangular bottom surface is regarded as a lateral direction,
pouring the liquid mixture into the tray-shaped container,
moving the liquid mixture in the tray-shaped container toward the other end in a first inclined state in which the bottom surface is inclined by making one of lateral ends higher than the other end,
subsequently, putting into a second inclined state in which the bottom surface is inclined oppositely by making the one lateral end lower than the other end, and
subsequently, spreading the bolus particles by putting the bottom surface into a horizontal state so as to spread.

2. The method for spreading the bolus particles according to claim 1, wherein a timing of changing the bottom surface from the first inclined state to the second inclined state is a timing at which a reverse flow occurs in the liquid mixture moving to the other end by changing the bottom surface to the first inclined state.

3. The method for spreading the bolus particles according to claim 2, wherein a timing of changing the bottom surface from the second inclined state to the horizontal state is a timing at which a reverse flow occurs in the liquid mixture moving to the one end by changing the bottom surface to the second inclined state.

4. The method for spreading the bolus particles according to claim 1, wherein the operation changing the bottom surface to the first inclined state and the operation changing the bottom surface to the second inclined state are repeated by turns several times.

5. An observation device for bolus particles comprising:
a tray-shaped container to which a liquid mixture of a bolus and adjusting agent is poured;
a housing having a mounting stand on which the tray-shaped container is mounted; and
a camera provided in an inside of the housing and acquiring image of the tray-shaped container so as to generate image data of bolus particles spread in the tray-shaped container,
characterized in that
the mounting stand can be changed to a horizontal posture in which a bottom surface of the tray-shaped container is in a horizontal state, a first inclined posture realizing a first inclined state in which the bottom surface of the tray-shaped container is inclined for a predetermined angle, and a second inclined posture realizing a second inclined state in which the bottom surface of the tray-shaped container is inclined oppositely to the first inclined posture,
the bottom surface is changed from the horizontal state to the first inclined state, and a timing of changing the bottom surface from the first inclined state to the second inclined state is a timing at which a reverse flow occurs in the liquid mixture moving by changing the bottom surface to the first inclined state, and
a timing of changing the bottom surface from the second inclined state to the horizontal state is a timing at which a reverse flow occurs in the liquid mixture moving by changing the bottom surface to the second inclined state, whereby the bolus particles in the tray-shaped container are spread.

6. A method for preparing the liquid mixture of the bolus and the adjusting agent according to claim 1, comprising:
a step washing the bolus with a first surfactant; and
a step washing the bolus with a second surfactant having polarity different from the first surfactant.

7. The method for preparing the liquid mixture according to claim 6, wherein the first surfactant is liquid whose main component is Yashinomi detergent and the second surfactant is liquid whose main component is Osvan liquid.

8. The method for preparing the liquid mixture according to claim 6, wherein the adjusting agent is the second surfactant.

9. (canceled)
